(19) United States
(12) Patent Application Publication
(10) Pub. No.: US 2009/0229948 A1
(43) Pub. Date: Sep. 17, 2009

(54) Key card operated switch of a walk-substituting cart

(76) Inventor: Ming-Hung Tsai, Chia Yi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,911

(22) Filed: Mar. 12, 2008

(51) Int. Cl. G07F 7/10

(52) U.S. Cl. 194/210

(57) ABSTRACT

A walk-substituting cart includes a body, a steering head member, a power device, and a switch to switch on the power device; the switch includes a mother board fixed in a hollowness of an uppermost portion of the steering head member, a dip switch on the mother board, a card reading member fixed behind the mother board, and a key card matching the dip switch; the dip switch is electrically connected to the power device; the card reading member is connected to the dip switch; the key card will close the circuit of the dip switch, and in turn the dip switch will turn on the power device of the cart when the key card is inserted in the card reading member; the original controlling mechanism of the power device doesn't have to be altered to allow the key card operated switch to be installed to serve its purpose.

### BACKGROUND OF THE INVENTION

1. Field of the invention

The present invention relates to a key card operated switch of a walk-substituting cart, more particularly one, which can prevent the cart from being stolen, and includes a mother board with a dip switch connected to a power device of the cart, and a key card matching the dip switch; when the key card is inserted in the card reading member, it will close the circuit of the dip switch, and in turn the dip switch will turn on the power device.

2. Brief Description of the Prior Art

Walk-substituting carts usually include an electric motor, and a storage battery to supply direct current to the electric motor. Only a small amount of heat energy will be produced from friction when the motor of such an electric walk-substituting cart is running with electric energy being transformed into kinetic energy. In other words, there is virtually no byproduct. Furthermore, because electric motors run on the principle of magnetic attraction and repulsion, such walk-substituting carts will produce much less noise than internal combustion engine vehicles. Therefore, it doesn't produce pollution or noise to ride electric walk-substituting carts. And, walk-substituting carts are usually ridden by the elderly or used for transporting golfer on a golf course.

An ordinary walk-substituting cart includes a chassis, rear wheels fitted to the chassis, a steering head member pivoted on a front of the chassis, a front wheel on a lower end of the steering head member, a power source on the chassis, a chair, and a switch to switch on/off the power source. The switch includes a socket, and a starter; the power source will be switched on to rotate the rear wheel when the starter is inserted in the socket.

The above walk-substituting cart is found to have the following drawbacks:

1. The cart can probably be started by means of a tool whose structure is similar to that of the genuine starter. Therefore, the cart can easily be stolen or used without the permission of the owner.

2. One can damage the steering head member, and short-circuit the switch to turn on the power source of the walk-substituting cart. Therefore, the cart can easily be stolen by a thief even if the thief doesn't have a tool similar to the starter.

### SUMMARY OF THE INVENTION

It is a main object of the present invention to provide a key card operated switch to a walk-substituting cart to overcome the above problems.

It is another object of the present invention to provide a key card operated switch, which can be installed on a walk-substituting cart to serve its purpose without altering the original controlling mechanism of the power device of the cart.

A key card operated switch according to an embodiment of the present invention includes a mother board, a dip switch, a card reading member, and a key card matching the dip switch; the walk-substituting cart includes a body, a steering head member, and a power device besides the key card operated switch. The mother board is fitted to the steering head member while the dip switch is fitted on the mother board, and electrically connected to the power device. The card reading member is fixed behind the mother board, and connected to the dip switch. When the key card is inserted in the card reading member, the key card will close the circuit of the dip switch, and in turn the dip switch will turn on the power device.

The steering head member has a receiving hollowness in an uppermost portion to hold the mother board, and has a through hole behind the receiving hollowness for the key card to be passed through.

Furthermore, the dip switch has a safety fuse connected thereto, which will automatically burn off if an unauthorized person is trying to break the dip switch to use the cart without permission of the owner.

### BRIEF DESCRIPTION OF THE DRAWINGS

The present invention will be better understood by referring to the accompanying drawings, wherein:

FIG. 1 is a lateral sectional view of the present invention,

FIG. 2 is a perspective view of the present invention,

FIG. 3 is a perspective view of the mother board of the present invention, taken before a key card is inserted in the mother board, and

FIG. 4 is a perspective view of the key card being inserted in the mother board of the present invention.

### DETAILED DESCRIPTION OF THE PREFERRED EMBODIMENTS

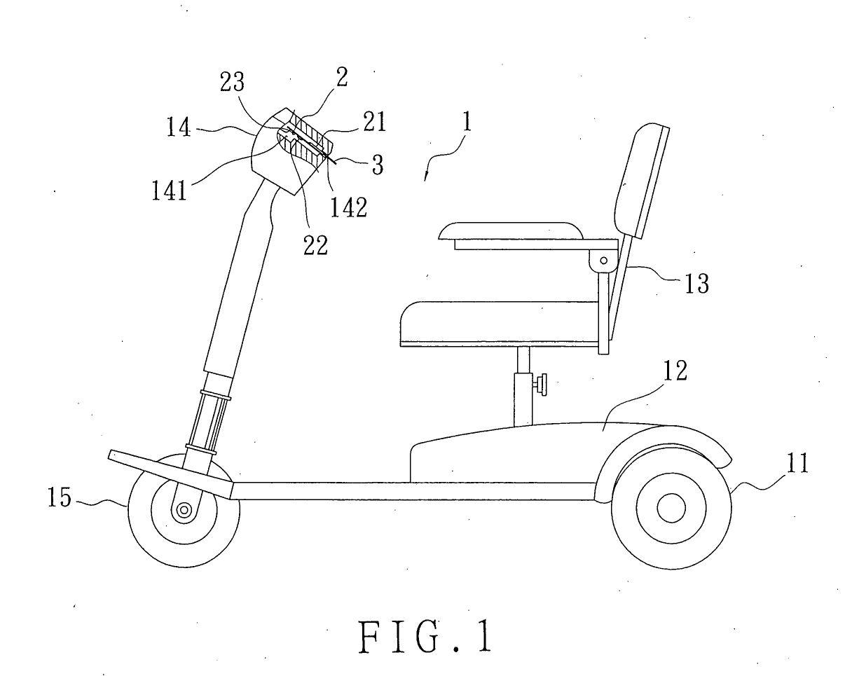

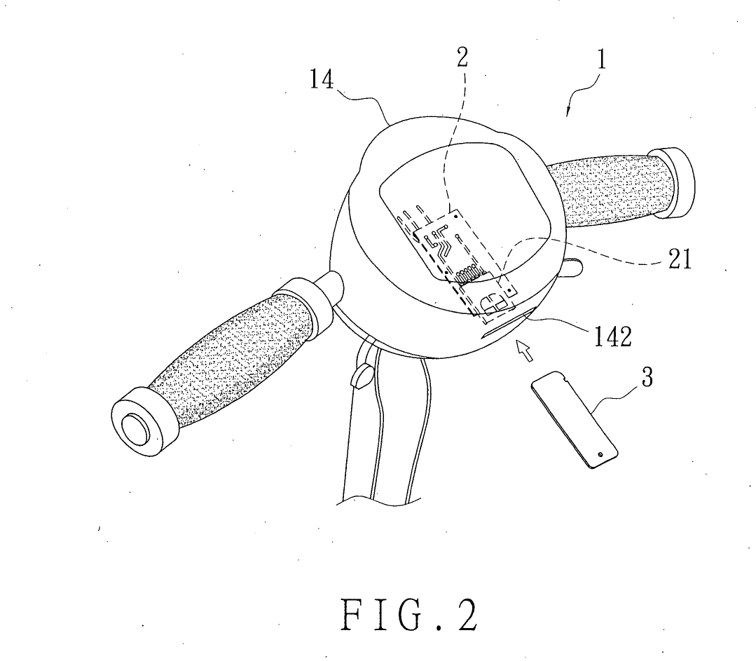

Referring to FIGS. 1 and 2, a preferred embodiment of a key card operated switch of a walk-substituting cart in the present invention consists of a mother board 2, and a key card 3; the walk-substituting cart has a body 1, rear wheels 11 joined on a bottom portion of a rear end of the body 1, a power device 12 installed on the body 1 to supply power to the rear wheels 11, a chair 13 secured above the power device 12, a steering head member 14 pivoted on a front end of the body 1, and a front wheel 15 on a lower end of the steering head member 14.

The steering head member 14 has a receiving hollowness 141 in an uppermost portion thereof, and a through hole 142 behind and in open communication with the receiving hollowness 141.

The mother board 2 is a printed circuit board (PCB), and fixed in the receiving hollowness 141 of the steering head member 14.

A dip switch 22 is fitted on the mother board 2 as well as the power device 12. The dip switch 22 is set to have a particular combination that matches the key card 3. Furthermore, the dip switch 22 is connected to a safety fuse 23; thus, the power supply will be automatically cut off if an unauthorized person is trying to break the dip switch 22.

A card reading member 21 is fixed on an upper side of a rear portion of the mother board 2 to receive and read the key card 3. The key card 3 is also a printed circuit board, and is made to have such a layout as to match the dip switch 22 so that the key card 3 will close the circuit of the dip switch 22 when inserted in the card reading member 21. The surface of the key card 3 can be printed to have a particular appearance according to the user's need.

In assembly, referring to FIGS. 1 and 2 again, the mother board 2 is fixed in the receiving hollowness 141 of the steering head member 14, and the power device 12 of the cart is electrically connected to the dip switch 22 fitted on the mother board 2 without altering an original controlling mechanism of the power device 12. Therefore, the user can use the key card 3 and the dip switch 22 to control the power device 12.

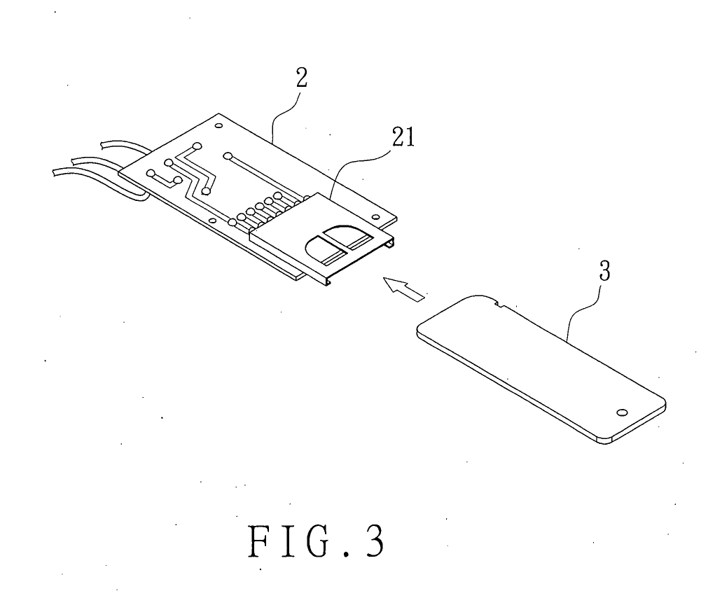

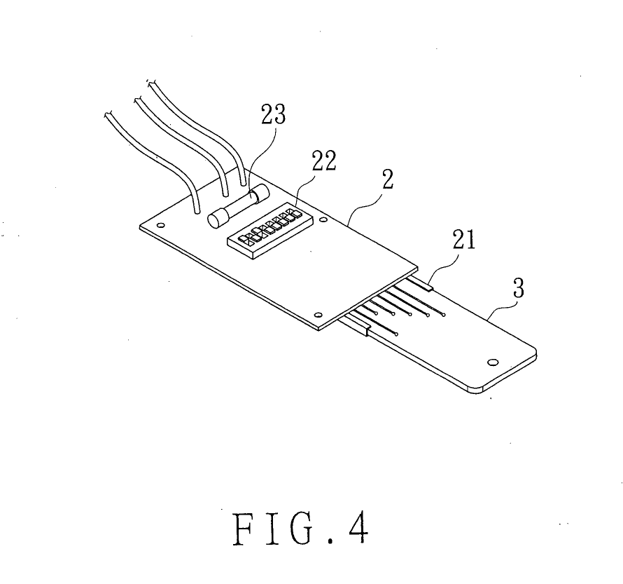

In use, referring to FIGS. 1, 3 and 4, the key card 3 is inserted in the card reading member 21 through the through hole 142 on the uppermost portion of the steering head member 14; thus, the key card 3 closes the circuit of the dip switch 22, and in turn 'the dip switch 22 switches on the power device 12. When the cart isn't in use, the user should pull the key card 3 out of the card reading member 21 so as to open the circuit of the dip switch 22; thus, the power device 12 is switched off. If an unauthorized person is trying to switch on the power device 12 of the cart with a fake key card that doesn't match the dip switch 22, the mother board 2 will produce warning signals, and temporarily shut off the power supply of the walk-substituting cart so that the cart won't be able to be used a certain length of time. Furthermore, if an unauthorized person is trying to break the steering head member 14 in order for him to change the circuit of the dip switch 22 into the closed state without using the key card 3, the safety fuse 23 will automatically burn off so as to prevent the walk-substituting cart from being stolen or used without permission of the owner.

From the above description, it can be seen that the present invention has the following advantages over the prior art:

1. The key card operated switch of the present invention includes the dip switch, which is electrically connected to the power device of the walk-substituting cart, and will switch on the power device when a key card that matches the dip switch is inserted in the card reading member on the mother board. And, the key card operated switch can be installed on the cart to serve its purpose without altering the original controlling mechanism of the power device. Furthermore, the key card can be printed to have a particular appearance according to the user's need. Therefore, the present invention is very commercially valuable.

2. The circuit of the dip switch only can be closed by means of the matching key card; if an unauthorized person is trying to switch on the power device of the cart with a fake key card that doesn't match the dip switch, the mother board will give a warning signal, and temporarily cut off the power supply to the walk-substituting cart so that the cart won't be able to be used a certain length of time.

3. If an unauthorized person is trying to damage the steering head member in order to change the circuit of the dip switch into the closed state without using the key card, the safety fuse will automatically burn off, thus preventing the walk-substituting cart from being stolen or used without permission of the owner.

What is claimed is:

1. A key card operated switch of a walk-substituting cart, comprising
a mother board joined on a steering head member of a walk-substituting cart, which steering head member is joined on a body of the cart; the cart having a power device installed on the body thereof;
a dip switch on the mother board; the dip switch being electrically connected to the power device;
a key card matching the finger-poked switch; and
a card reading member, the card reading member being connected to the dip switch; the card reading member being going to read the key card in order for the key card to close a circuit of the dip switch when the key card is connected with the card reading member.

2. The key card operated switch of a walk-substituting cart as claimed in claim 1, wherein the steering head member has a receiving hollowness, and the mother board is positioned in the receiving hollowness.

3. The key card operated switch of a walk-substituting cart as claimed in claim 2, wherein the steering head member has a through hole, which communicates with the receiving hollowness for allowing the key card to be moved onto the mother board therethrough.

4. The key card operated switch of a walk-substituting cart as claimed in claim 1, wherein the dip switch has a safety fuse connected thereto.
